(19) United States
(12) Patent Application Publication
(10) Pub. No.: US 2026/0050109 A1
(43) Pub. Date: Feb. 19, 2026

(54) MICRO DOMES ARRAY CAPABLE OF PRODUCING MULTICOLOR RETROREFLECTIVE GRAPHICS, METHOD FOR FABRICATING THE SAME, AND SYSTEM FOR GENERATING PIXELATED GRAPHIC

(71) Applicant: Korea Advanced Institute of Science and Technology, Daejeon (KR)

(72) Inventors: Shin-Hyun Kim, Daejeon (KR); Chaerim Son, Daejeon (KR)

(73) Assignee: Korea Advanced Institute of Science and Technology, Daejeon (KR)

(21) Appl. No.: 19/283,405

(22) Filed: Jul. 29, 2025

(30) Foreign Application Priority Data
Aug. 13, 2024 (KR) 10-2024-0107967

(51) Int. Cl. G02B 5/13; G02B 3/00; G02B 5/136

(52) U.S. Cl. CPC G02B 5/13; G02B 3/0012; G02B 3/0037; G02B 5/136

(57) ABSTRACT

A method for fabricating micro domes array according to an embodiment of the present invention includes forming a micro patterns array on a base substrate through a photolithography process, reflowing the micro patterns array to form micro dome patterns, forming a mold having concave curved surfaces corresponding to an inverse shape of the micro dome patterns, and forming a micro domes array using the mold. The micro domes array includes a base portion and a convex portion including micro domes protruding from a first surface of the base portion. A structural color is generated through retroreflection at convex surfaces of the micro domes.

### CROSS-REFERENCE TO RELATED APPLICATIONS

This application claims priority to and benefits of Korean Patent Application No. 10-2024-0107967 under 35 U.S.C. § 119 filed on Aug. 13, 2024 in the Korean Intellectual Property Office, the entire contents of which are incorporated herein by reference.

### BACKGROUND

### 1. Field

The present invention relates to a micro domes array capable of producing a structural color through retroreflection. More particularly, the present invention relates to a micro domes array capable of producing multicolor retroreflective graphics, method for fabricating the same and system for generating a pixelated graphic.

### 2. Description of the Related Art

Structural color is an optical phenomenon that occurs through wavelength-selective interference, diffraction, or scattering through light-matter interaction. Structural color can change color depending on a viewing angle and does not fade or change color unless the structure is changed. In addition, since the color is expressed purely by the structure, there is no toxicity caused by chemicals. This feature can be effectively utilized in a paint field, a security field such as an anti-counterfeiting patch, and a cosmetics field.

Conventional methods for expressing structural color mainly use nanostructures. The nanostructures have the problem that they are complicated to manufacture and expensive. Recently, research is being conducted on expressing structural color by curved interfaces.

For example, a high-refractive material (micro dome) with a convex surface and a diameter of several tens of micrometers can generate a structural color ring observed on the opposite side through multiple total reflections and interference of visible light on the convex surface.

In order to create two-dimensional graphics using micro domes, methods such as embedding microspheres or directly printing micro domes have been attempted. However, manufacturing time thereof is very long, and density of micro domes is limited to prevent adhesion of the micro domes, resulting in decrease of resolution.

### Prior Arts

1. U.S. Patent Publication US 2023-0185003
2. Korean Patent Publication KR 2020-0083237
3. Chinese Patent Publication CN 117980170

### SUMMARY

The present invention provides a micro domes array which can produce multicolor retroreflective graphics with a high resolution and can be fabricated by a simple and reliable method.

The present invention provides a method for fabricating a micro domes array.

The present invention provides a system for producing a pixelated graphic using a micro domes array.

A method for fabricating micro domes array according to an embodiment of the present invention includes forming a micro patterns array on a base substrate through a photolithography process, reflowing the micro patterns array to form micro dome patterns, forming a mold having concave curved surfaces corresponding to an inverse shape of the micro dome patterns, and forming a micro domes array using the mold. The micro domes array includes a base portion and a convex portion including micro domes protruding from a first surface of the base portion. A structural color is generated through retroreflection at convex surfaces of the micro domes.

In an embodiment, a ratio of a height to a width of the micro patterns is 0.5 to 4.

In an embodiment, an angle formed by a curved surface of the micro dome patterns with respect to an upper surface of the base substrate is 60° or more.

In an embodiment, the micro dome array includes at least one selected from the group consisting of polydimethylsiloxane, polystyrene, polyester, polymethylmethacrylate, polyurethane, polyamide, polyethylene, polypropylene and polycarbonate.

In an embodiment, reflowing the micro patterns array is performed at 60° C. to 200° C.

In an embodiment, the micro patterns array is formed from a positive photoresist.

In an embodiment, forming the mold includes coating a resin composition on the micro dome patterns, curing the resin composition and separating a curing body from the micro dome patterns and the base substrate.

In an embodiment, forming the micro domes array includes coating a resin composition on the concave curved surfaces of the mold, curing the resin composition and separating a curing body from the mold.

In an embodiment, a diameter of the micro domes in a plan view is 5□ to 50□.

In an embodiment, a refractive index of the micro domes is 1.35 to 1.70.

In an embodiment, the base portion and the micro domes includes a same material.

In an embodiment, the micro patterns have a pillar shape, and the micro domes have a hemisphere shape.

In an embodiment, the micro patterns have a linear shape extending in a direction, and the micro domes have a hemicylindrical shape.

In an embodiment, the convex portion includes a first micro dome and a second micro dome, which have different curvature radii. A first structural color generated by a light retroreflected at a convex surface of the first micro dome has a different color from a second structural color generated by a light retroreflected at a convex surface of the second micro dome.

In an embodiment, the micro patterns array includes a first micro pattern having a first width and a second micro pattern having a second width smaller than the first width. The first and second micro patterns have a same height. A first micro dome pattern formed by reflow of the first micro pattern has a height greater than a height of a second micro dome pattern formed by reflow of the second micro pattern.

A micro domes array according to an embodiment of the present invention includes a base portion and a convex portion including micro domes protruding from a first surface of the base portion. The base portion and the convex portion include a same material. The micro domes include a first micro dome and a second micro dome, which have different curvature radii. A first structural color generated by a light retroreflected at a convex surface of the first micro dome has a different color from a second structural color generated by a light retroreflected at a convex surface of the second micro dome.

A system for producing a pixelated graphic according to an embodiment of the present invention includes a micro domes array including a first pixel area and a second pixel area. The first pixel area includes a plurality of first subpixel areas, and the second pixel area includes a plurality of second subpixel areas. A first micro dome having a convex surface is disposed in at least one of the first subpixel areas, and a second micro dome having a convex surface with a curvature radius different from the convex surface of the first micro dome is disposed in at least one of the second subpixel areas. A first structural color generated by a light retroreflected at the convex surface of the first micro dome has a different color from a second structural color generated by a light retroreflected at the convex surface of the second micro dome.

According to the embodiments of the present invention, since micro domes with various curvature radius are simultaneously generated from micro pillars having a same single height with different diameters using a single-step reflow process, a multi structural color graphic may be generated by selecting a desired color combination. In addition, a change in brightness may be expressed by adjusting an interval between the micro domes.

The photolithography process for manufacturing the micro pillars and the reflow process for converting the micro pillars into the micro domes may be precisely controlled, and reproducibility thereof is high. Thus, the size and shape of the micro dome may be consistently maintained. Therefore, structural color may be precisely generated with high reliability on a large area.

In addition, unlike structural color by nanostructures that require periodic arrangement, since color is expressed by a single micro dome structure, micro domes of different sizes may be mixed in a small area, or the density of the micro domes may be changed, thereby expressing various colors and brightness.

### BRIEF DESCRIPTION OF THE DRAWINGS

FIGS. 1, 4 and 9 are plan views illustrating a method for fabricating a micro domes array according to an embodiment of the present invention.

FIGS. 2, 5, 6, 7, 8 and 10 are cross-sectional views illustrating a method for fabricating a micro domes array according to an embodiment of the present invention.

FIG. 3 is a plan view illustrating micro pillars in a method for fabricating a micro domes array according to an embodiment of the present invention.

FIG. 11 is a cross-sectional view for explaining the structural color generation of a micro domes array according to an embodiment of the present invention.

FIG. 12 is an enlarged cross-sectional view of a single micro dome of a micro domes array according to an embodiment of the present invention.

FIG. 13 is a schematic diagram for explaining change in structural color according to compression of a micro domes array according to an embodiment of the present invention.

FIG. 14 is a plan view illustrating a micro patterns array in a method for fabricating a micro domes array according to another embodiment of the present invention.

FIG. 15 is a perspective view illustrating micro dome patterns obtained from the micro patterns array of FIG. 14.

FIG. 16 is a schematic diagram illustrating a method for manufacturing a micro domes array according to Example 1 of the present invention.

FIG. 17 shows a scanning electron microscope (SEM) image (a) of the micro pillars array (average diameter of micro pillars 13.5 μm, distance between pillars 10 μm) of Example 1 and an SEM image (b) of the micro dome pattern obtained after reflow.

FIG. 18 shows optical photographs of the micro domes array of Example 1 (average diameter of micro pillars 13.5 μm, distance between pillars 10 μm) (a) taken from the convex side and (b) taken from the flat side, and an enlarged photograph (c) taken from the flat side.

FIG. 19 shows optical photographs (the right is enlarged) taken from the flat side when light was irradiated at an incident angle of 31° to the micro domes array of Example 1 (average diameter of micro domes 13.5 μm, distance between columns 10 μm).

FIG. 20 shows SEM images of micro-pillars (left) of various diameters and micro-dome patterns (right) formed therefrom in Example 1.

FIG. 21 shows images showing the structural colors of micro-dome arrays obtained according to the diameters of micro-pillars in Example 1.

FIG. 22 shows a stereoscopic microscope image (a) and an enlarged image (b) of structural color graphics obtained through a combination of dots (transmission areas) and blank areas having different sizes in a photomask, and a dot array (c) of the photomask in an enlarged area.

FIG. 23 is a photograph showing the structural colors (1:0, 0:1) obtained from a single diameter micro dome and the structural colors (3:1, 1:1, 1:3) obtained by combining micro domes of different diameters.

FIG. 24 shows an image (a) and an enlarged image (b) of the multicolor structural color graphic obtained by combining micro domes of different diameters.

FIG. 25 shows an SEM photograph (top) of the micro domes array of Example 2, a structural color photograph by vertical irradiation (middle), and a structural color photograph by oblique irradiation (bottom).

FIG. 26 shows a photograph (left) of a single structural color graphic generated by the micro domes array and a photograph of an enlarged area (right).

FIG. 27 is a plan view illustrating a micro domes array according to an embodiment of the present invention.

FIG. 28 shows a pixelated graphic image using a micro domes array.

### DETAILED DESCRIPTION

Various embodiments will be described more fully hereinafter with reference to the accompanying drawings, in which some embodiments are shown. The present invention may, however, be embodied in many different forms and should not be construed as limited to the embodiments set forth herein. Rather, these embodiments are provided so that this description will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or parts, these elements, components, regions, layers and/or parts should not be limited by these terms. These terms are only used to distinguish one element, component, region, layer or part from another region, layer or part. Thus, a first element, component, region, layer or part discussed below could be termed a second element, component, region, layer or part without departing from the teachings of the present invention.

The terminology used herein is for the purpose of describing particular embodiments only and is not intended to be limiting of the present invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

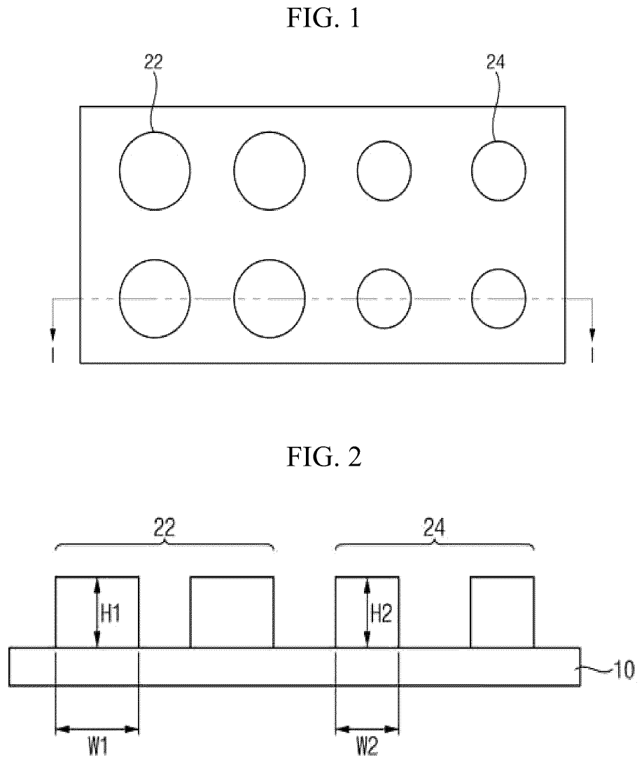

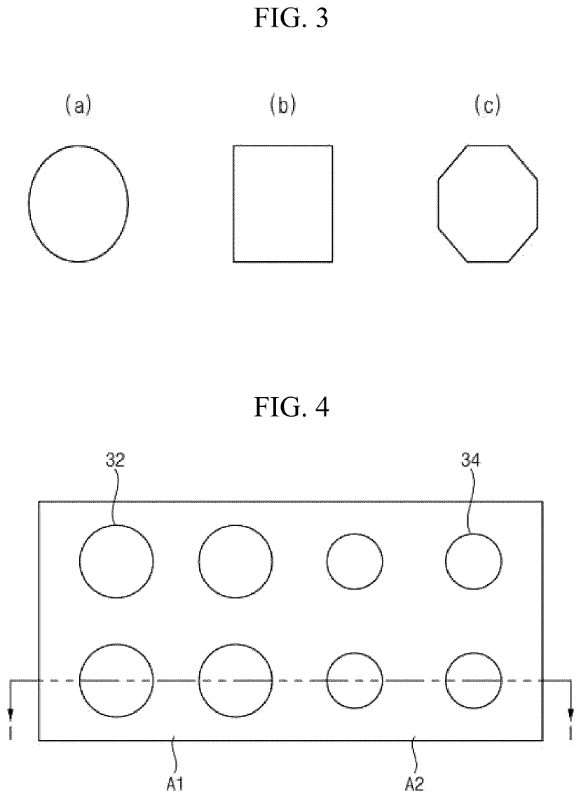

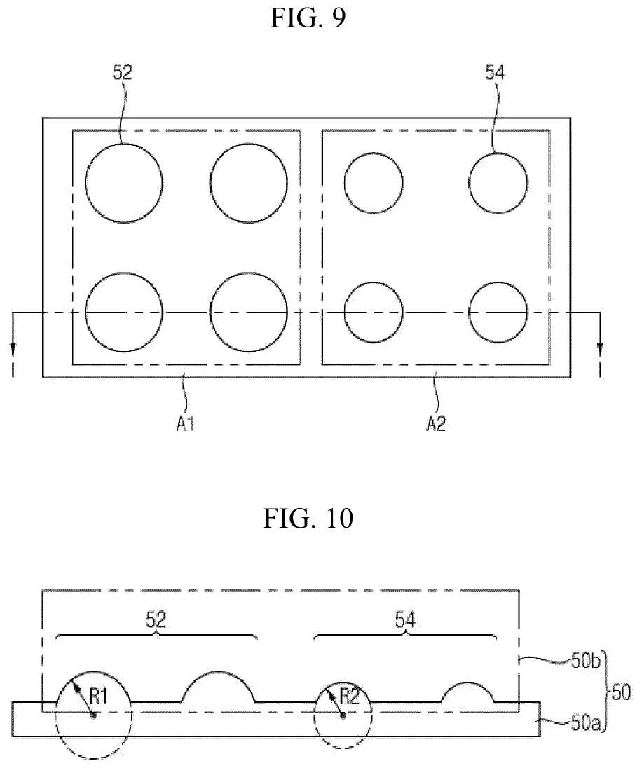

FIGS. 1, 4 and 9 are plan views illustrating a method for fabricating a micro domes array according to an embodiment of the present invention. FIGS. 2, 5, 6, 7, 8 and 10 are cross-sectional views illustrating a method for fabricating a micro domes array according to an embodiment of the present invention. In particular, FIGS. 2, 5, 6, 7, 8, and 10 illustrates a cross-sectional view taken along the line I-I′ in FIGS. 1, 4 and 9. FIG. 3 is a plan view illustrating micro pillars in a method for fabricating a micro domes array according to an embodiment of the present invention.

Referring to FIGS. 1 and 2, a plurality of micro patterns are formed on a base substrate 10. The micro patterns may form a micro dome pattern through a subsequent reflow process.

According to an embodiment, the micro patterns may be micro pillars having a micro level width Diameter) W1 and W2. For example, the ratio of the height to the width of the micro pillar (aspect ratio) H1/W1 or H2/W2 may be 0.5 to 4 or 0.7 to 1.8. When the aspect ratio is too small, a lens-shaped pattern rather than a dome-shaped pattern may be obtained after reflow.

According to an embodiment, the micro pillars may include a plurality of patterns having different widths. For example, the micro pillars may include a first micro pillar 22 having a first width W1 and a second micro pillar 24 having a second width W2 smaller than the first width W1. The micro pillars may be formed from a same photoresist film (photosensitive film). Therefore, the height H1 of the first micro pillar 22 and the height H2 of the second micro pillar 24 may be the same.

The first micro pillar 22 and the second micro pillar 24 may be formed in multiples to form a group. Alternatively, the first micro pillars 22 may be dispersed between the second micro pillars 24.

However, the embodiments of the present invention are not limited thereto, and the micro pillars array may include three or more micro pillars having different widths, or may consist of micro pillars having a same single width.

According to an embodiment, the micro pillars may be micro pillars having a circular shape in a plan view. However, the embodiments of the present invention are not limited thereto, and as shown in FIG. 3, in addition to a circular shape (a), they may have various shapes such as a square shape (b), an octagon shape (c), etc. In addition, the micro pillars may have different plane shapes. For example, the first micro pillar 22 may have a square shape, and the second micro pillar 24 may have a circular shape, in a plan view.

The base substrate 10 may include various materials such as silicon, quartz, glass, and polymer. The base substrate 10 may be preferable to include a material with high heat resistance so that a shape thereof may be maintained during the reflow process.

The micro pillars may be formed through a photolithography process. For example, a photoresist composition is applied on the base substrate 10 to form a photosensitive film. Thereafter, a portion corresponding to the micro pillar in the photosensitive film is selectively exposed, or a portion corresponding to the micro pillar is masked and the remaining portion is selectively exposed. Thereafter, a developer is provided to the photosensitive film to remove a portion not corresponding to the micro pillar, thereby forming the micro pillar.

According to an embodiment, the photoresist composition may be a positive type. When the photoresist composition is a positive type, the solubility increases by exposure, so that the portion corresponding to the micro pillars may be masked and the exposure process may be performed. When the photoresist composition is a negative type, a crosslinking reaction occurs by exposure, so that it may be difficult to control shape deformation by reflow.

The photoresist composition may include a polymer. For example, the photoresist composition may include a phenol resin, an epoxy resin, an acrylic resin, etc., and a commercial positive photoresist composition may be used.

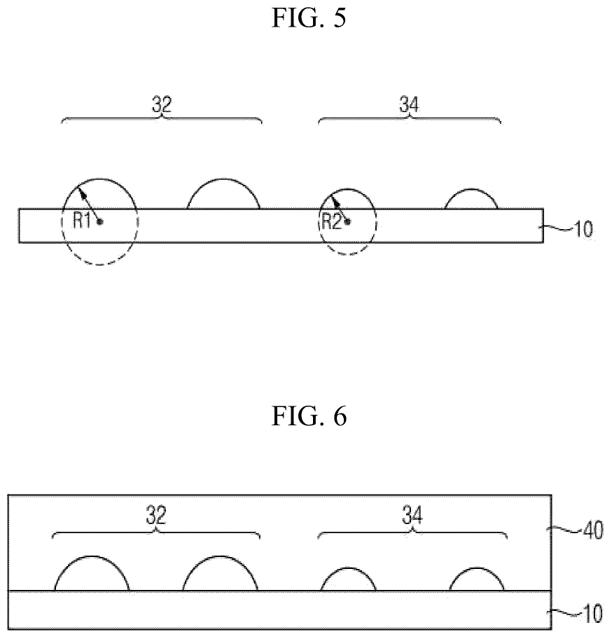

Referring to FIGS. 4 and 5, the micro pillars are heated to form micro dome patterns through reflow. The micro dome pattern may be defined as a pattern that forms a dome shape by having a convex surface. For example, the micro dome pattern may have a hemisphere shape, which has a circular shape on a plan view. In order to distinguish the dome pattern from the lens pattern, the dome pattern may be defined as having a three-dimensional shape defined by a convex curved surface and a flat bottom surface, and having a contact angle (the angle formed by the curved surface with respect to a base surface) of 60° or more.

When the micro pillar includes first and second micro pillars of different widths, the micro dome patterns formed therefrom may also have different sizes. For example, the first micro dome pattern 32 formed from the first micro pillar 22 may have a first curvature radius R1, and the second micro dome pattern 34 formed from the second micro pillar 24 may have a second curvature radius R2 smaller than the first curvature radius R1.

Since the micro dome pattern is formed through a reflow process, the micro dome pattern may have a larger width than the micro pillar. Therefore, the width D1 of the first micro dome pattern 32 is larger than the width W1 of the first micro pillar, and the width D2 of the second micro dome pattern 34 is larger than the width W2 of the second micro pillar. For example, the width of the micro dome pattern may be 1.1 to 1.3 times larger than the width of the micro pillar.

The micro dome pattern may have a lower height than the micro pillar. In addition, micro dome patterns formed from micro pillars of different widths may have different heights. For example, the height Ha of the first micro dome pattern 32 may be larger than the height Hb of the second micro dome pattern 34.

For example, the heating temperature for the reflow process may be 60° C. to 200° C. According to an embodiment, the reflow process may be performed at a temperature 15° C. to 35° C. higher than the hard bake temperature of the micro pillar. For example, the reflow process may be performed at 125° C. to 145° C. When the reflow process temperature is too low, a continuous curved surface may not be obtained, which may decrease the structural color intensity. When the reflow process temperature is too high, the curvature radius may increase, which may change the micro dome pattern into a micro lens shape, and it is difficult to induce internal total reflection in the micro lens structure.

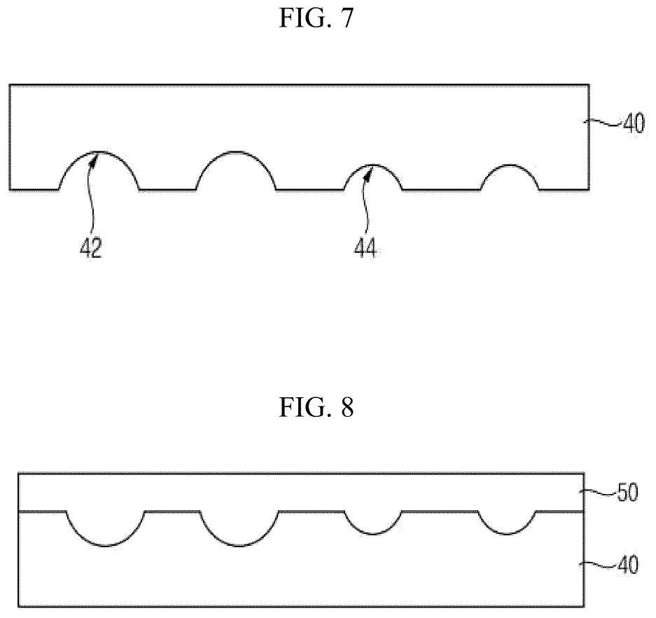

Referring to FIGS. 6 and 7, a mold resin is coated on the base substrate 10 on which the micro dome patterns are formed, and cured to form a mold 40 having concave curved surfaces 42 and 44 corresponding to the micro dome patterns. After forming the mold 40, the base substrate 10 and the micro dome patterns 32 and 34 may be removed from the mold 40.

According to an embodiment, polydimethylsiloxane (PDMS) may be used as a material for forming the mold 40. However, the embodiments of the present invention are not limited thereto, and various mold materials capable of transferring the shape of the micro dome patterns may be used.

Referring to FIGS. 8 to 10, a micro domes array 50 is obtained from the mold 40. For example, as shown in FIG. 8, a resin composition may be applied on the concave curved surfaces 42 and 44 of the mold 40, and cured to obtain the micro domes array 50. However, the embodiments of the present invention are not limited thereto, and after applying the resin composition on a substrate, the shape of the mold 40 may be transferred by pressurizing the resin composition with the mold 40.

The resin composition according to an embodiment may be a composition for forming polydimethylsiloxane. However, the embodiments of the present invention are not limited thereto, and various resin compositions having an appropriate refractive index, for example, a refractive index of 1.35 to 1.70 after curing, may be used. For example, the micro domes array 50 may include polydimethylsiloxane, polystyrene, polyester, polymethylmethacrylate, polyurethane, polyamide, polyethylene, polypropylene, polycarbonate, or a combination thereof.

According to an embodiment, the micro domes array 50 may include a base portion 50a and a convex portion 50b. The base portion 50a may have a two-dimensional film shape extending in a horizontal direction. The convex portion 50b may include a plurality of micro domes protruding from a first surface of the base portion 50a and having convex surfaces SS1 and SS2. The base portion 50a and the convex portion 50b may be formed integrally to include a same material.

The second surface of the base portion 50a may have a flat shape. Thus, the second surface of the base portion 50a may form a flat surface (a light-exiting surface of retroreflected light) of the micro domes array.

According to an embodiment, the convex portion 50b may include a first micro dome 52 having a first curvature radius R1 and a second micro dome 54 having a second curvature radius R2 smaller than the first curvature radius R1.

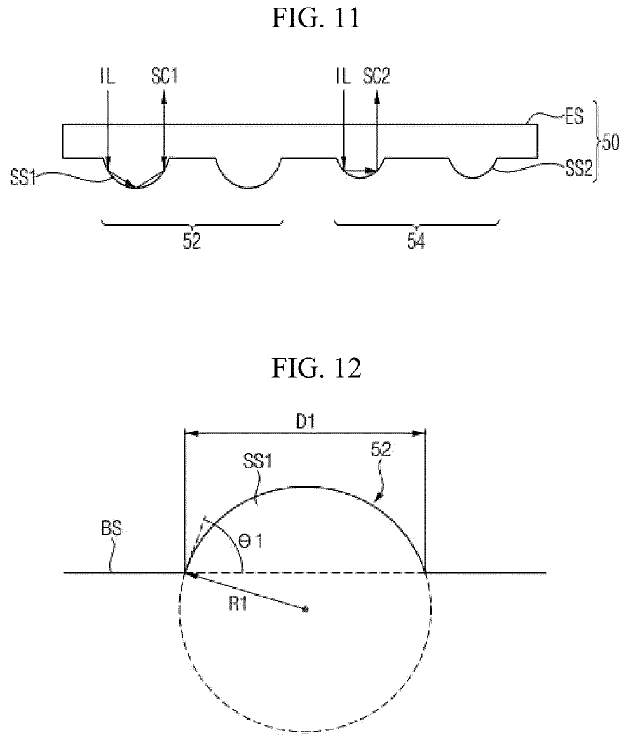

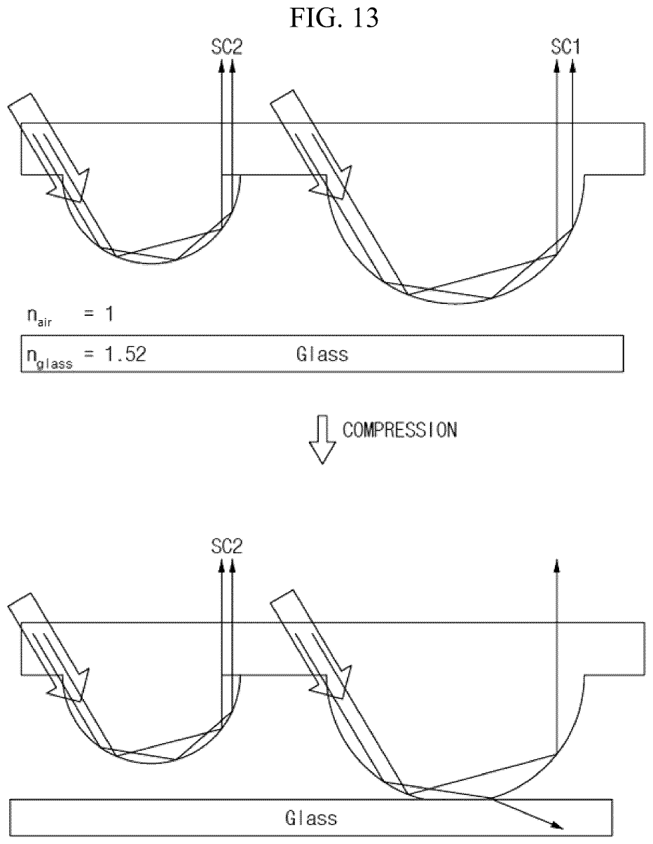

FIG. 11 is a cross-sectional view for explaining the structural color generation of a micro domes array according to an embodiment of the present invention. FIG. 12 is an enlarged cross-sectional view of a single micro dome of a micro domes array according to an embodiment of the present invention. FIG. 13 is a schematic diagram for explaining change in structural color according to compression of a micro domes array according to an embodiment of the present invention.

Referring to FIG. 11, when light entering the micro domes array 50 is incident on the convex surfaces SS1 and SS2 of the micro domes at an angle greater than the critical angle (=sin⁻¹(n1/n2), n1=refractive index of the external medium, n2=refractive index of the micro dome), it may be totally reflected. For example, when the external medium is air (refractive index=1) and the micro domes array includes PDMS (refractive index=1.41), the critical angle may be 44.7°.

The totally reflected light may be incident on the convex surfaces SS1 and SS2 again, and thus, multiple total reflections may occur along the convex surfaces SS1 and SS2. A light incident on the light exit surface ES exits from the micro domes array 50 to the outside. As interference occurs between lights having different reflection counts, a structural color may be observed in a ring shape along a periphery of the micro domes when observed from the light-exiting surface ES.

The structural color may vary depending on curvature radius, refractive index, observation angle, refractive index of the surrounding medium, etc. of the micro domes. For example, the structural color of the first light SC1 exiting after being totally reflected from the first convex surface SS1 of the first micro dome 52 may be different from the structural color of the second light SC2 exiting after being totally reflected from the second convex surface SS2 of the second micro dome 54. For example, the structural color of the first light SC1 may have a color with a longer wavelength than the structural color of the second light SC2. Therefore, a first area A1 where the first micro domes 52 are arranged and a second area A2 where the second micro domes 54 are arranged may generate different structural colors. Therefore, by combining micro domes that generate different structural colors, a multicolored structural color graphic may be produced. In addition, by combining micro domes having the first structural color and micro domes having the second structural color in the same or different ratios, a third structural color different from the first structural color and the second structural color may be recognized by an external observer.

In the present application, “structural color” is not limited to a color having saturation, and may include white or a color close to white. In addition, “first structural color”, “second structural color”, etc. are not used to intend a specific color, but are used to distinguish different colors, and may mean any color including chromatic and achromatic colors.

Hereinafter, a specific shape of the first micro dome 52 will be described with reference to FIG. 12. The following description may be equally applied to the shape of the second micro dome 54.

The diameter D1 of the first micro dome 52 may be defined as a diameter of a circular shape on a plan view projected on the base plane BS connecting edges of the first convex surface SS1. The base plane BS may correspond to a first surface of the base portion 50a. When the diameter of the first micro dome 52 is excessively large, multiple reflection peaks occur in the visible range, it may be difficult to generate structural color. When the diameter of the first micro dome 52 is excessively small, a path where total reflection may occur is reduced, which may reduce brightness of the structural color. According to an embodiment, the diameter of the first micro dome 52 may be 5 μm to 50 μm, 8 μm to 30 μm, or 10 μm to 25 μm.

According to an embodiment, an angle (θ1, contact angle) of the first convex surface SS1 with respect to the base plane BS may be 60° or more, preferably 70° or more, and more preferably 80° or more. For example, the contact angle may be 70° to 110° or 80° to 100°. When the contact angle is too small, a shape similar to a lens may be formed, and the brightness of the structural color may be weakened.

The structural color may appear well when directional light (e.g., directional white light) is irradiated onto the micro domes array, and may not appear when non-directional light such as ambient light is incident because interference intensity therefrom is low. Therefore, the micro domes array may be transparent in a normal environment and may have a structural color that appears when directional light is irradiated. By utilizing these characteristics, the micro domes array may be used to produce an identification mark such as an anti-counterfeiting pattern.

In addition, when an external force is applied, the structural color may be selectively or sequentially changed according to the height of the micro domes. Referring to FIG. 13, a first structural color SC1 may be generated by a first micro dome, and a second structural color SC2 may be generated by a second micro dome having a height smaller than that of the first micro dome. When the micro domes array is compressed or pressed, the first micro dome firstly contacts a floor, and the total reflection on the curved surface of the first micro dome decreases due to a change in the refractive index of the external medium (refractive index of air>refractive index of the floor material (ex: glass)). Thus, the first structural color SC1 is not generated. When compression progresses further, the second micro dome may contact the floor so that the second structural color SC2 may not be generated.

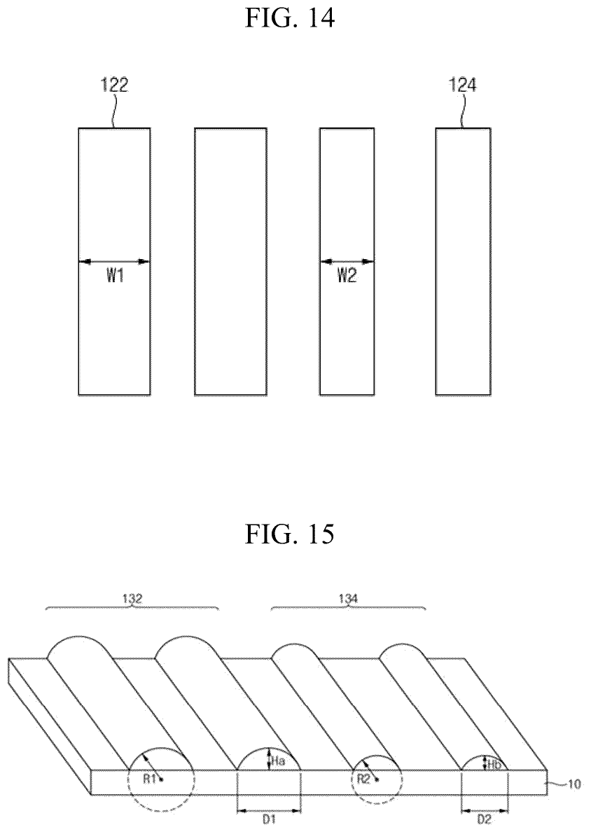

FIG. 14 is a plan view illustrating a micro patterns array in a method for fabricating a micro domes array according to another embodiment of the present invention. FIG. 15 is a perspective view illustrating micro dome patterns obtained from the micro patterns array of FIG. 14.

Referring to FIG. 14, micro patterns formed through photolithography may have a shape of a linear pattern extending in one direction on a plan view. In the micro patterns, a width may be defined as a length of a short side. For example, the micro patterns array may include a first micro pattern 122 having a first width W1 and a second micro pattern 124 having a second width W2 smaller than the first width W1. The cross-sectional shapes of the first micro pattern 122 and the second micro pattern 124 may be substantially the same as the cross-sectional shapes of the first micro pillar 22 and the second micro pillar 24 illustrated in FIG. 2.

Referring to FIG. 15, a first micro dome pattern 132 and a second micro dome pattern 134 having a hemicylindrical shape may be formed from the first micro pattern 122 and the second micro pattern 124 through a reflow process. The cross sections of the first micro dome pattern 132 and the second micro dome pattern 134 may be identical to the cross sections of the first micro dome pattern 32 and the second micro dome pattern 34 illustrated in FIG. 5.

After a mold is formed using the first micro dome pattern 132 and the second micro dome pattern 134 to have an inverse shape thereof, a micro domes array having a convex portion having the same shape as the first micro dome pattern 132 and the second micro dome pattern 134 may be formed using the mold.

As described above, a micro domes array having a cylindrical dome shape may also generate structural color. However, since it is not a hemispherical dome, structural color may be observed at a periphery of the curve along a length direction of the cylinder.

FIG. 27 is a plan view illustrating a micro domes array according to an embodiment of the present invention.

The micro domes array according to an embodiment of the present invention may be used to generate pixelated graphics (images).

Referring to FIG. 27, the micro domes array may include a first pixel area P1 and a second pixel area P2. The first pixel area P1 may include a plurality of first subpixel areas SP1, and the second pixel area P2 may include a plurality of second subpixel areas SP2. The first pixel area P1 and the second pixel area P2 may have a same size, and the first subpixel area SP1 and the second subpixel area SP2 may have different sizes.

According to one embodiment, the first subpixel area SP1 may have a larger size than the second subpixel area SP2, and the number of the first subpixel areas SP1 in the first pixel area P1 may be smaller than the number of the second subpixel areas SP2 in the second pixel area P2. For example, the first pixel area P1 may include first subpixel areas SP1 arranged in an n×n matrix (n is a natural number greater than 2, and the second pixel area P2 may include second subpixel areas SP2 arranged in an m×m matrix (m is a natural number greater than n).

The first pixel area P1 may display an achromatic color. For example, the first pixel area P1 may display white, black, gray, or a combination thereof. In the first pixel area P1, at least one first micro dome 62 that generates a first structural color corresponding to white is arranged. The first subpixel area SP1 where the first micro dome 62 is not arranged may express black. The entire gradation of the first pixel area P1 or a certain area may be expressed by a combination of the first subpixel area SP1 where the first micro dome 62 is arranged and the first subpixel area SP1 where the first micro dome 62 is not arranged.

The second pixel area P2 may display a chromatic color. In the second pixel area P2, at least one second micro dome 64 that generates a second structural color corresponding to the chromatic color is arranged. The convex surface of the second micro dome 64 may have a different curvature radius from the convex surface of the first micro dome 62. Accordingly, the second micro dome 64 may generate a different structural color from the first micro dome 62. For example, the diameter of the second micro dome 64 on a plan view may be smaller than the diameter of the first micro dome 62 on a plan view.

A plurality of second micro domes 64 may be arranged in the second pixel area P2. Micro domes that generate different structural colors (having convex surfaces with different curvature radius) may be arranged in the second pixel area P2. By combining different structural colors in a unit pixel area, a different color that is not generated by an individual micro dome may be expressed. For example, a second micro dome that generates a second structural color and a third micro dome that generates a third structural color may be arranged in the second pixel area P2. The micro domes that generate different structural colors may have different sizes. The second pixel area P2 may include a second subpixel area SP2 where the micro dome is not arranged. The second subpixel area SP2 where the micro dome is arranged may express black.

According to embodiments of the present invention, since micro domes with various curvature radius are simultaneously generated from micro pillars having a same single height with different diameters using a single-step reflow process, a multi structural color graphic may be generated by selecting a desired color combination. In addition, a change in brightness may be expressed by adjusting an interval between the micro domes.

The photolithography process for manufacturing the micro pillars and the reflow process for converting the micro pillars into the micro domes may be precisely controlled, and reproducibility thereof is high. Thus, the size and shape of the micro dome may be consistently maintained. Therefore, structural color may be precisely generated with high reliability on a large area.

In addition, unlike structural color by nanostructures that require periodic arrangement, since color is expressed by a single micro dome structure, micro domes of different sizes may be mixed in a small area, or the density of the micro domes may be changed, thereby expressing various colors and brightness.

Based on the above, an image to be generated may be pixelated and a primary color (RGB) value may be extracted from each pixel, and each pixel may be expressed by combination of a micro dome of a specific size and an empty space without the micro dome. As a result, an image with a high resolution almost identical to the original image may be reproduced.

Hereinafter, a method for manufacturing a micro domes array according to exemplary embodiments and its effects will be described in detail through specific experimental examples. However, the experimental examples are provided only as examples, and the scope of the present invention is not limited to the contents provided in the experimental examples.

### Example 1

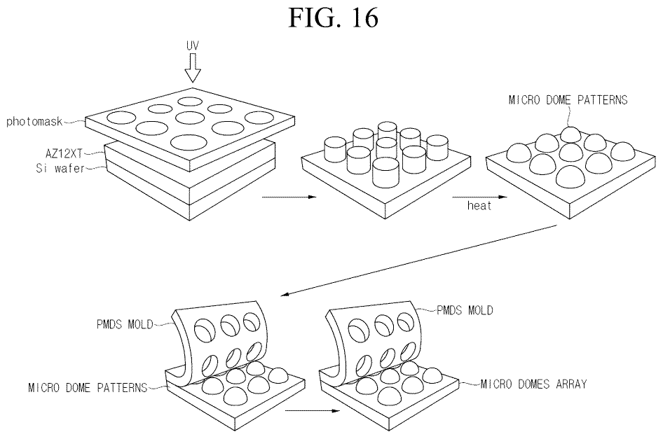

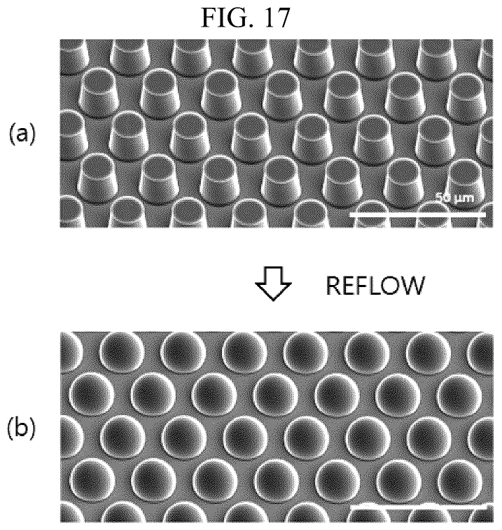

FIG. 16 is a schematic diagram illustrating a method for manufacturing a micro domes array according to Example 1 of the present invention. As shown in FIG. 16, a micro domes array was obtained through the following method.

A surface of a silicon wafer was treated with hexamethyldisilazane to be hydrophobic. Positive photoresist (AZ12XT-20PL-10, AZ Electronic Materials) was spin-coated on the silicon wafer at 2,000 rpm for 10 seconds, and then soft-baked at 105° C. for 180 seconds to obtain a photoresist film with a thickness of 14 μm.

Thereafter, UV exposure was performed at 195 mW/cm² through a photomask having a micro dots array, and baking was performed at 90° C. for 60 seconds. The exposed photoresist film was developed with an alkaline solution (AZ300MIF, AZ Electronic Materials) to form a micro pillars array with a height of 13.6 μm.

In order to reflow the micro pillars, the wafer was heated to 135° C. for 5 minutes on a hot plate to form a micro dome pattern from the micro pillars.

A mixture of PDMS prepolymer (Sylgard 184, Dow Corning) and a curing agent (weight ratio of prepolymer:curing agent=10:1) was poured onto the micro dome pattern and cured at 80° C. for 4 hours in an oven. Thereafter, the PDMS mold (having the negative shape of the micro dome pattern) was treated with oxygen plasma for 300 seconds and treated with trichloro(1H,1H,2H,2H-perfluorooctyl)silane (Sigma-Aldrich) through deposition. The PDMS mixture (prepolymer+curing agent) was filled into the PDMS mold, cured, and peeled off to obtain a PDMS micro domes array.

FIG. 17 shows a scanning electron microscope (SEM) image (a) of the micro pillars array (average diameter of micro pillars 13.5 μm, distance between pillars 10 μm) of Example 1 and an SEM image (b) of the micro dome pattern obtained after reflow.

Referring to FIG. 17, it can be noted that a dome-shaped pattern may be obtained through a reflow process.

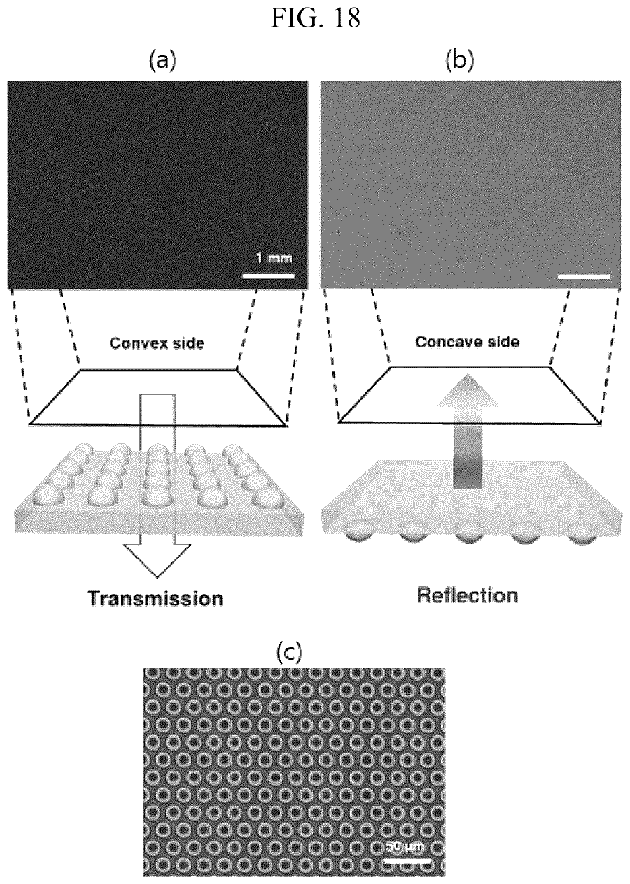

FIG. 18 shows optical photographs of the micro domes array of Example 1 (average diameter of micro pillars 13.5 μm, distance between pillars 10 μm) (a) taken from the convex side and (b) taken from the flat side, and an enlarged photograph (c) taken from the flat side. In order to confirm the structural color, light was irradiated perpendicularly to the incident surface.

Referring to FIG. 18, no color appears when observed from the convex side of the micro domes array, but magenta appears when observed from the flat side. It was confirmed that a color ring is formed at the periphery of each micro dome by retroreflection due to total internal reflection.

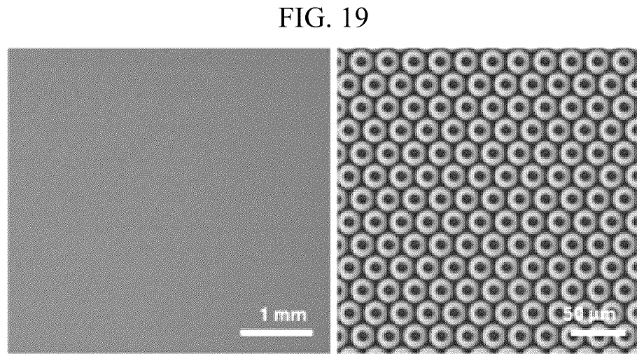

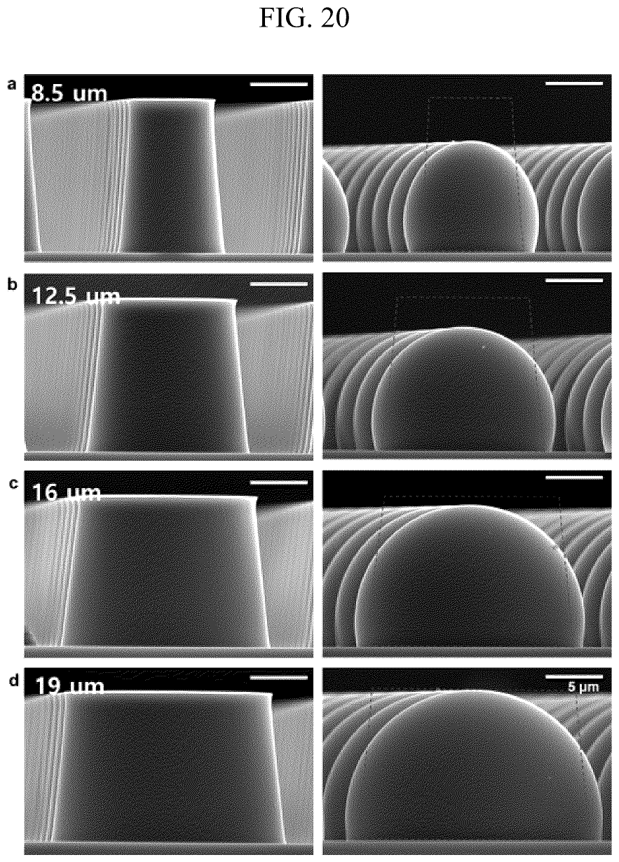

FIG. 19 shows optical photographs (the right is enlarged) taken from the flat side when light was irradiated at an incident angle of 31° to the micro domes array of Example 1 (average diameter of micro domes 13.5 μm, distance between columns 10 μm).

Referring to FIG. 19, it can be noted that observed color varies depending on the angle incident on a micro domes array.

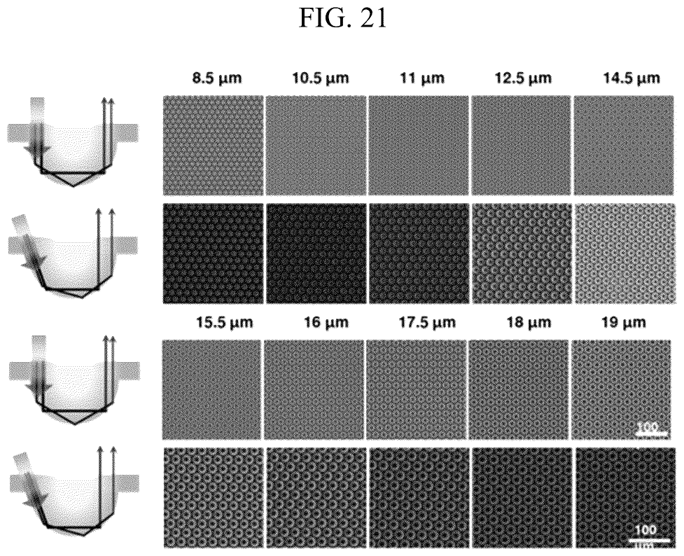

FIG. 20 shows SEM images of micro-pillars (left) of various diameters and micro-dome patterns (right) formed therefrom in Example 1. FIG. 21 shows images showing the structural colors of micro-dome arrays obtained according to the diameters of micro-pillars in Example 1. The upper images in FIG. 21 show the structural colors due to light irradiated perpendicularly to the incident surface, and the lower images show the structural colors due to light irradiated at an incident angle of 31°.

Referring to FIGS. 20 and 21, it can be noted that by controlling widths of micro-pillars, micro-dome patterns of different curvature radii may be obtained, and different structural colors may be obtained therefrom.

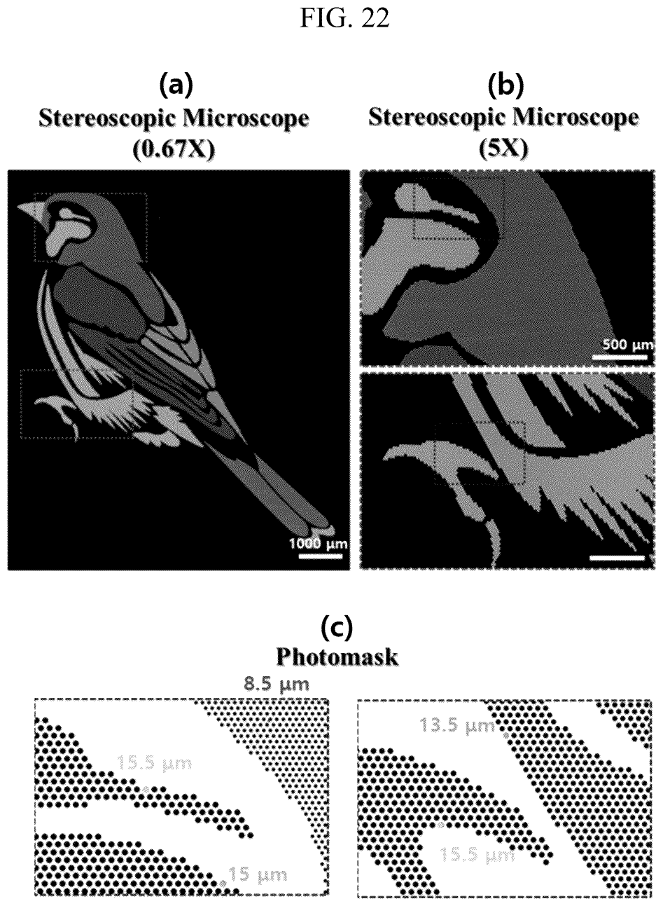

FIG. 22 shows a stereoscopic microscope image (a) and an enlarged image (b) of structural color graphics obtained through a combination of dots (transmission areas) and blank areas having different sizes in a photomask, and a dot array (c) of the photomask in an enlarged area.

Referring to FIG. 22, it can be noted that a multi structural color graphic may be produced by combining dot sizes (diameters of micro-pillars) of a photomask.

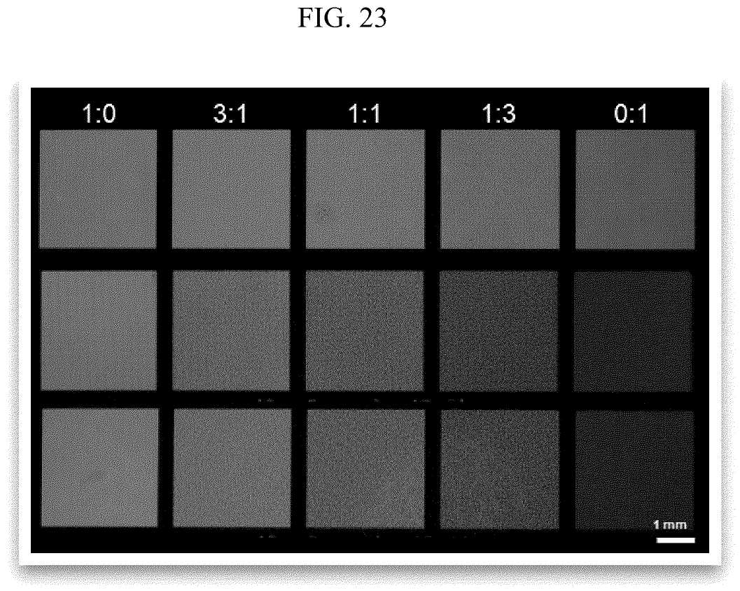

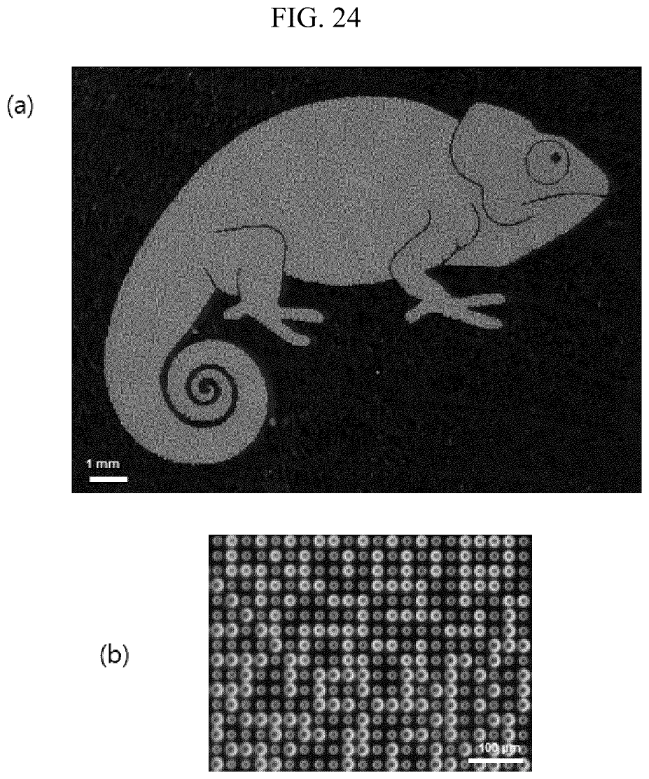

FIG. 23 is a photograph showing the structural colors (1:0, 0:1) obtained from a single diameter micro dome and the structural colors (3:1, 1:1, 1:3) obtained by combining micro domes of different diameters. FIG. 24 shows an image (a) and an enlarged image (b) of the multicolor structural color graphic obtained by combining micro domes of different diameters.

Referring to FIGS. 23 and 24, it can be noted that color mixing is possible by combining micro domes of different diameters.

### Example 2

Except for using a linear micro patterns array (the line width gradually changes from 8 μm to 22 μm with a difference of 0.5 μm) through a photolithography process, a process was carried out in the same manner as Example 1 to form a hemi-cylinder-shaped micro domes array.

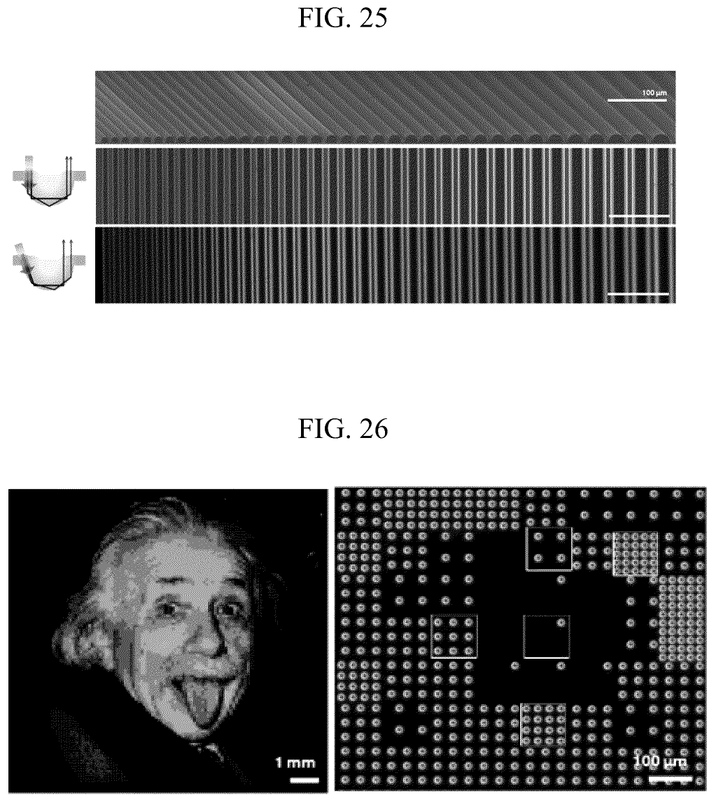

FIG. 25 shows an SEM photograph (top) of the micro domes array of Example 2, a structural color photograph by vertical irradiation (middle), and a structural color photograph by oblique irradiation (bottom).

Referring to FIG. 25, it can be noted that a hemi-cylinder-shaped micro domes array generating multicolor structural colors was obtained by controlling the line width of the linear micro pattern.

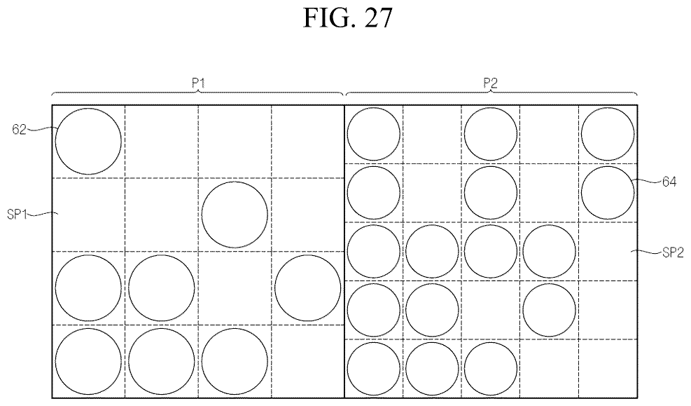

FIG. 26 shows a photograph (left) of a single structural color graphic generated by the micro domes array and a photograph of an enlarged area (right). Referring to FIG. 26, it can be noted that brightness may be expressed by adjusting a density of micro domes in a unit area (for example, arranging 1, 4, 9, 16, and 25 micro domes per unit area).

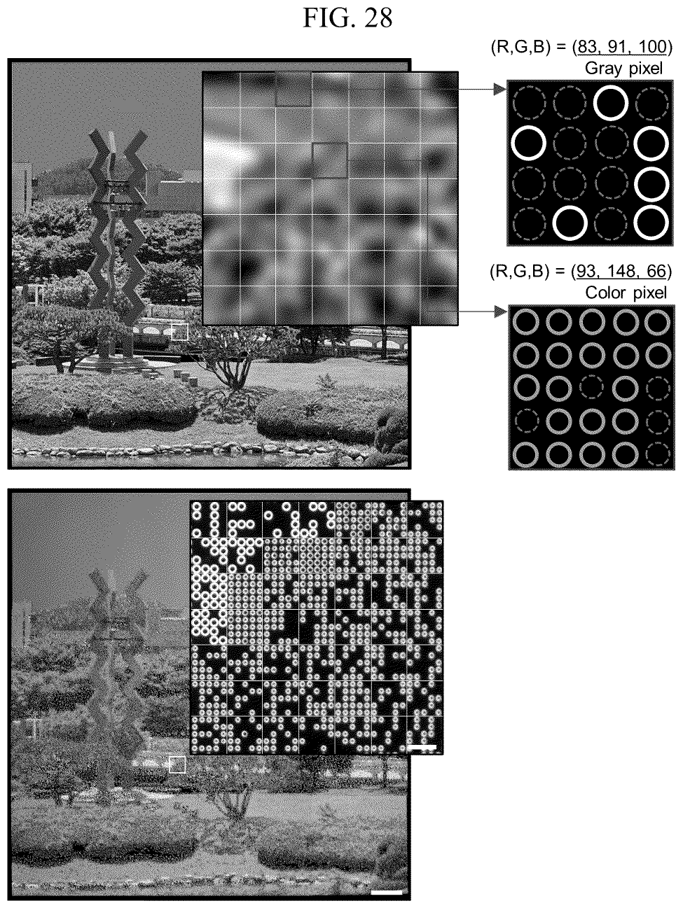

FIG. 28 shows a pixelated graphic image using a micro domes array.

Specifically, the original image (upper image) was pixelated, and RGB values for each pixel were extracted. The pixels were classified into chromatic pixels and achromatic pixels based on the deviation of the RGB values. For example, when □R-G□²+□G-B□²+□B-R□² is greater than 500, the corresponding pixel was classified as a chromatic pixel. In order to generate a chromatic pixel, a 5×5 matrix with a size of 128×128 μm² was used, the sizes of micro domes representing 11 different colors were selected, and the density was adjusted to appropriately match the RGB values assuming linear correlation. In order to generate achromatic pixels, a 4×4 matrix having a size of 128×128 μm² was used, and 17 levels of gradation were expressed using micro domes formed from micro pillars with an average diameter of 26 μm. The original image (KAIST campus) was digitized into pixels of 210×215, and was regenerated into 33,543 chromatic pixels and 11,607 achromatic pixels. Referring to FIG. 28, it can be noted that high-resolution multicolor graphics may be generated through the embodiment of the present invention.

Structural color micro particles according to exemplary embodiments of the present invention may be used in decorative articles, display devices, signs, anti-counterfeiting marks, etc.

As described above, the present invention has been described with reference to exemplary embodiments, but it will be understood by those skilled in the art that various modifications and changes may be made to the present invention without departing from the spirit and scope of the present invention described in the following patent claims.

### Description of Reference Numerals

10: base substrate
22, 24: micro pillar
32, 34: micro dome pattern
40: mold
50: micro domes array
50a: base portion
50b: convex portion
52, 54, 62, 64: micro dome
SS1, SS2: convex surface

What is claimed is:

1. A method for fabricating micro domes array, the method comprising:
forming a micro patterns array on a base substrate through a photolithography process;
reflowing the micro patterns array to form micro dome patterns;
forming a mold having concave curved surfaces corresponding to an inverse shape of the micro dome patterns; and
forming a micro domes array using the mold,
wherein the micro domes array includes a base portion and a convex portion including micro domes protruding from a first surface of the base portion, and
a structural color is generated through retroreflection at convex surfaces of the micro domes.

2. The method of claim 1, wherein a ratio of a height to a width of the micro patterns is 0.5 to 4.

3. The method of claim 1, wherein an angle formed by a curved surface of the micro dome patterns with respect to an upper surface of the base substrate is 60° or more.

4. The method of claim 1, wherein the micro domes array includes at least one selected from the group consisting of polydimethylsiloxane, polystyrene, polyester, polymethylmethacrylate, polyurethane, polyamide, polyethylene, polypropylene and polycarbonate.

5. The method of claim 1, wherein reflowing the micro patterns array is performed at 60° C. to 200° C.

6. The method of claim 1, wherein the micro patterns array is formed from a positive photoresist.

7. The method of claim 1, wherein forming the mold includes:
coating a resin composition on the micro dome patterns;
curing the resin composition; and
separating a curing body from the micro dome patterns and the base substrate.

8. The method of claim 1, wherein forming the micro domes array includes:
coating a resin composition on the concave curved surfaces of the mold;
curing the resin composition; and
separating a curing body from the mold.

9. The method of claim 1, wherein a diameter of the micro domes in a plan view is 5 μm to 50 μm.

10. The method of claim 1, wherein a refractive index of the micro domes is 1.35 to 1.70.

11. The method of claim 1, wherein the base portion and the micro domes includes a same material.

12. The method of claim 1, wherein the micro patterns have a pillar shape, and the micro domes have a hemisphere shape.

13. The method of claim 1, wherein the micro patterns have a linear shape extending in a direction, and the micro domes have a hemicylindrical shape.

14. The method of claim 11, wherein the convex portion includes a first micro dome and a second micro dome, which have different curvature radii,
wherein a first structural color generated by a light retroreflected at a convex surface of the first micro dome has a different color from a second structural color generated by a light retroreflected at a convex surface of the second micro dome.

15. A micro domes array including a base portion and a convex portion including micro domes protruding from a first surface of the base portion,
wherein the base portion and the convex portion include a same material,
wherein the micro domes include a first micro dome and a second micro dome, which have different curvature radii,
wherein a first structural color generated by a light retroreflected at a convex surface of the first micro dome has a different color from a second structural color generated by a light retroreflected at a convex surface of the second micro dome.

16. The micro domes array of claim 15, wherein an angle formed by the convex surfaces of the micro domes with respect to an upper surface of the base substrate is 60° or more.

17. The micro domes array of claim 15, wherein a diameter of the first and second micro domes in a plan view is 5 μm to 50 μm, and a refractive index of the convex portion is 1.35 to 1.70.

18. A system for producing a pixelated graphic, including a micro domes array including a first pixel area and a second pixel area,
wherein the first pixel area includes a plurality of first subpixel areas, and the second pixel area includes a plurality of second subpixel areas,
wherein a first micro dome having a convex surface is disposed in at least one of the first subpixel areas, and a second micro dome having a convex surface with a curvature radius different from the convex surface of the first micro dome is disposed in at least one of the second subpixel areas,
wherein a first structural color generated by a light retroreflected at the convex surface of the first micro dome has a different color from a second structural color generated by a light retroreflected at the convex surface of the second micro dome.

19. The system of claim 18, wherein the first pixel area and the second pixel area have a same size, and the first subpixel area has a larger size than the second subpixel area.

20. The system of claim 19, wherein the first structural color is white, and the second structural color is a chromatic color.
